(19) United States
(12) Patent Application Publication
(10) Pub. No.: US 2011/0102400 A1
(43) Pub. Date: May 5, 2011

(54) LIQUID CRYSTAL DISPLAY

(76) Inventor: Juhyun Ji, Paju-si (KR)

(21) Appl. No.: 12/770,412

(22) Filed: Apr. 29, 2010

(30) Foreign Application Priority Data
Nov. 5, 2009 (KR) 10-2009-0106606

(51) Int. Cl. G09G 5/00; G09G 3/36

(52) U.S. Cl. 345/211; 345/98

(57) ABSTRACT

A liquid crystal display is disclosed. The liquid crystal display includes a liquid crystal display panel on which a plurality of data lines and a plurality of gate lines cross each other and a plurality of liquid crystal cells are formed at crossings of the data lines and the gate lines, a DC-DC converter that produces a high potential power voltage required to drive the liquid crystal display panel and a gate low voltage required to generate a scan pulse for driving the gate lines, and a common voltage generating circuit that divides the high potential power voltage based on the gate low voltage to generate a common voltage to be applied to a common electrode of the liquid crystal cells.

This application claims the benefit of Korean Patent Application No. 10-2009-0106606 filed on Nov. 5, 2009, which is incorporated herein by reference for all purposes as if fully set forth herein.

### BACKGROUND OF THE INVENTION

1. Field of the Invention

Exemplary embodiments of the invention relate to a liquid crystal display, and more particularly to a liquid crystal display capable of preventing a reduction of image quality resulting from changes of a panel load.

2. Discussion of the Related Art

A general liquid crystal display adjusts a light transmittance of liquid crystals using an electric field, thereby displaying an image. For this, the liquid crystal display includes a liquid crystal display panel, on which liquid crystal cells are arranged in a matrix form, and a power voltage generating circuit generating voltages required to drive the liquid crystal display panel.

As shown in FIG. 1, the liquid crystal display panel includes gate lines GL and data lines DL, that cross each other, and thin film transistors (TFTs) that are respectively formed at crossings of the gate lines GL and the data lines DL to drive liquid crystal cells Clc. The liquid crystal display panel further includes storage capacitors Cst for holding a voltage of the liquid crystal cells Clc. Each of the liquid crystal cells Clc includes a pixel electrode, a common electrode, and a liquid crystal layer. An electric field is applied to the liquid crystal layer of the liquid crystal cells Clc by a data voltage applied to the pixel electrode and a common voltage Vcom applied to the common electrode. An amount of light passing through the liquid crystal layer is adjusted by the electric field, thereby displaying an image.

The power voltage generating circuit is implemented by a direct current (DC)-to-DC converter generating a plurality of power voltages. As shown in FIG. 2, the DC-DC converter increases or reduces an input voltage Vin inside a charge pumping unit 2 in response to a switch control signal input through a boosting switch to output the voltages required to drive the liquid crystal display panel. The output voltages of the DC-DC converter include a gate high voltage VGH equal to or greater than 15V, a gate low voltage VGL equal to or less than −3V, and the like. The charge pumping unit 2 includes a plurality of diodes and a plurality of capacitors. In the DC-DC converter, a pumping capacitor unit 1 including a plurality of pumping capacitors FC1 to FC4 is connected between the boosting switch and the charge pumping unit 2.

A level of the output voltage of the DC-DC converter, for example, a level of the gate high voltage VGH or a level of the gate low voltage VGL is determined by capacitances of the pumping capacitors FC1 to FC4. The capacitances of the pumping capacitors FC1 to FC4 are generally very less than capacitances of capacitors inside the charge pumping unit 2. As shown in FIG. 3, when a panel load changes because of changes of a data pattern or changes of a driving frequency, the level of the output voltage of the DC-DC converter, for example, the level of the gate high voltage VGH or the level of the gate low voltage VGL changes because of the low capacitances of the pumping capacitors FC1 to FC4. For example, when the driving frequency changes from 60 Hz to 75 Hz, the panel load increases by a predetermined amount, and thus a supply current of the pumping capacitor unit 1 is insufficient. Hence, the level of the gate high voltage VGH falls, and the level of the gate low voltage VGL rises.

As shown in FIG. 4, changes of the level of the gate high voltage VGH and changes of the level of the gate low voltage VGL result in changes of a feed-through voltage, and as a result an optimum common voltage level required in the liquid crystal display panel varies. A magnitude of the feed-through voltage is known to be proportional to a difference between the gate high voltage VGH and the gate low voltage VGL. The optimum common voltage level of the panel has to be set so that a positive pixel voltage Vp(+) and a negative pixel voltage Vp(−) are symmetric to each other with the common voltage Vcom interposed therebetween. When the change of the panel load (for example, a rise in the driving frequency) results in a rise in the level of the gate high voltage VGH and a fall in the level of the gate low voltage VGL, the feed-through voltage decreases from ΔVp to ΔVp′. Therefore, the level of the common voltage Vcom has to be upwardly shifted to the optimum common voltage level required in the panel so as to achieve a symmetric structure between a positive pixel voltage Vp(+)′ and a negative pixel voltage Vp(−)′.

However, because the related art common voltage Vcom is produced by dividing a power voltage with a fixed level, an output level of the related art common voltage Vcom is fixed to an initial setting value. Therefore, when the panel load changes as shown in FIG. 4, there is a difference between the fixed level of the common voltage Vcom and the optimum common voltage level required in the panel. As a result, when the same data voltage is applied to pixels, the positive pixel voltage Vp(+)′ and the negative pixel voltage Vp(−)′ charged to the pixels do not have the symmetric structure because of the difference between the fixed level of the common voltage Vcom and the optimum common voltage level of the panel. As a result, the image quality is reduced because of a side effect such as crosstalk, smear, flicker, and image sticking.

### SUMMARY OF THE INVENTION

Exemplary embodiments of the invention provide a liquid crystal display capable of preventing a reduction of image quality resulting from changes of a panel load.

In one aspect, there is a liquid crystal display comprising a liquid crystal display panel on which a plurality of data lines and a plurality of gate lines cross each other and a plurality of liquid crystal cells are formed at crossings of the data lines and the gate lines, a DC-DC converter that produces a high potential power voltage required to drive the liquid crystal display panel and a gate low voltage required to generate a scan pulse for driving the gate lines, and a common voltage generating circuit that divides the high potential power voltage based on the gate low voltage to generate a common voltage to be applied to a common electrode of the liquid crystal cells.

The common voltage generating circuit includes a first input terminal to which the high potential power voltage is input, a second input terminal to which the gate low voltage is input, a plurality of resistors that are positioned between the first and second input terminals and divide the high potential power voltage based on the gate low voltage, and an output node that outputs a voltage divided by the resistors as the common voltage.

The common voltage generating circuit further includes a filter unit for removing a harmonic component from the gate low voltage applied through the second input terminal. The filter unit is implemented by a RC filter.

The common voltage generating circuit further includes a common voltage compensation unit connected to the output node. The common voltage compensation unit is implemented by an inverting amplifier including an operational amplifier (op-amp).

The op-amp has a non-inverting terminal, that is connected to the output node and receives the common voltage, and an inverting terminal receiving a feedback common voltage from the liquid crystal display panel. The common voltage compensation unit inverts and amplifies the feedback common voltage from the liquid crystal display panel based on the common voltage input through the output node, and then again supplies the amplified common voltage to the liquid crystal display panel, thereby removing a ripple component of the feedback common voltage.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an equivalent circuit diagram of one pixel of a liquid crystal display;

FIG. 2 schematically illustrates a general configuration of a DC-DC converter;

FIG. 3 is a waveform diagram illustrating changes of output voltages of a DC-DC converter resulting from changes of a panel load;

FIG. 4 illustrates a difference between a fixed level of a common voltage and an optimum common voltage level required in a panel when a panel load changes;

FIG. 5 is a block diagram of a liquid crystal display according to an exemplary embodiment of the invention;

FIG. 6 is a circuit diagram illustrating an exemplary configuration of a common voltage generating circuit;

FIG. 7 illustrates an example of changing a level of a common voltage around an optimum common voltage level required in a panel when a panel load changes;

FIG. 8 is a circuit diagram illustrating another exemplary configuration of a common voltage generating circuit; and

FIG. 9 is a circuit diagram illustrating another exemplary configuration of a common voltage generating circuit.

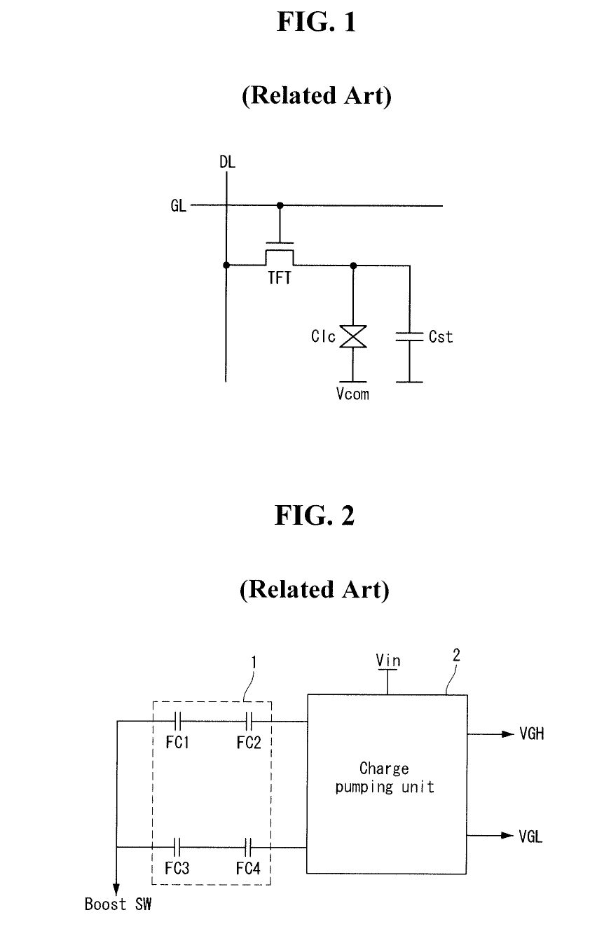

### DETAILED DESCRIPTION OF THE EMBODIMENTS

Reference will now be made in detail embodiments of the invention examples of which are illustrated in the accompanying drawings.

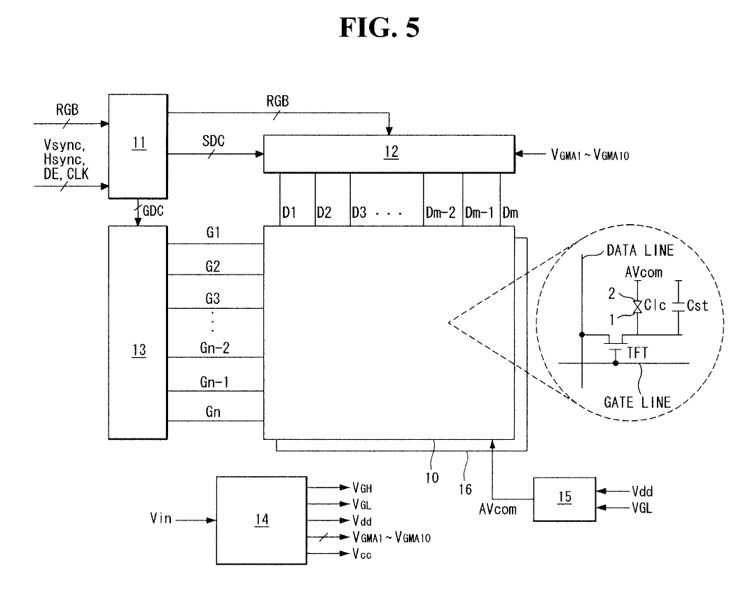

FIG. 5 is a block diagram of a liquid crystal display according to an exemplary embodiment of the invention. As shown in FIG. 5, a liquid crystal display according to an exemplary embodiment of the invention includes a liquid crystal display panel 10, a timing controller 11, a data driving circuit 12, a gate driving circuit 13, a DC-DC converter 14, a common voltage generating circuit 15, and a backlight unit 16.

The liquid crystal display panel 10 includes an upper glass substrate, a lower glass substrate, and a liquid crystal layer between the upper and lower glass substrates. The liquid crystal display panel 10 further includes liquid crystal cells Clc that are arranged in a matrix form in accordance with a crossing structure of a plurality of data lines D1 to Dm and a plurality of gate lines G1 to Gn.

The data lines D1 to Dm, the gate lines G1 to Gn, thin film transistors (TFTs), and storage capacitors Cst are formed on the lower glass substrate of the liquid crystal display panel 10. The liquid crystal cells Clc are connected to the TFTs and are driven by an electric field between pixel electrodes 1 and a common electrode 2. A black matrix, a color filter, and the common electrode 2 are formed on the upper glass substrate of the liquid crystal display panel 10. In a vertical electric field driving manner such as a twisted nematic (TN) mode and a vertical alignment (VA) mode, the common electrode 2 is formed on the upper glass substrate. In a horizontal electric field driving manner such as an in-plane switching (IPS) mode and a fringe field switching (FFS) mode, the common electrode 2 is formed on the lower glass substrate along with the pixel electrodes 1. An electric field is applied to the liquid crystal layer by a data voltage applied to the pixel electrode 1 and a common voltage AVcom applied to the common electrode 2. While an arrangement of liquid crystal molecules of the liquid crystal layer changes by the electric field, an amount of light passing through the liquid crystal layer may be adjusted. Polarizing plates are respectively attached to the upper and lower glass substrates of the liquid crystal display panel 10. Alignment layers for setting a pre-tilt angle of liquid crystals are respectively formed on the upper and lower glass substrates of the liquid crystal display panel 10.

The timing controller 11 receives timing signals such as a vertical synchronous signal Vsync, a horizontal synchronous signal Hsync, a data enable signal DE, and a dot clock CLK and generates control signals GDC and SDC for controlling operation timings of the data driving circuit 12 and the gate driving circuit 13.

The gate control signal GDC for controlling the operation timing of the gate driving circuit 13 includes a gate start pulse GSP indicating a start horizontal line of a scan operation during 1 vertical period in which one screen is displayed, a gate shift clock GSC that is input to a shift resistor inside the gate driving circuit 13 to sequentially shift the gate start pulse GSP and has a pulse width corresponding to an ON-period of the TFT, a gate output enable signal GOE indicating an output of the gate driving circuit 13, and the like.

The data control signal SDC for controlling the operation timing of the data driving circuit 12 includes a source sampling clock SSC indicating a data latch operation inside data driving circuit 12 based on a rising or falling edge, a source output enable signal SOE indicating an output of the data driving circuit 12, a polarity control signal POL indicating a polarity of the data voltage to be supplied to the liquid crystal cells Clc of the liquid crystal display panel 10, and the like.

The timing controller 11 rearranges digital video data RGB received from an external system board in conformity with a resolution of the liquid crystal display panel 10 and supplies the rearranged digital video data RGB to the data driving circuit 12.

The data driving circuit 12 includes a plurality of source driver integrated circuits (ICs). Each of the source driver ICs samples and latches the digital video data RGB received from the timing controller 11 in response to the data control signal SDC and converts the latched digital video data RGB into deserialized data. Each source driver IC converts the deserialized data into an analog gamma compensation voltage using positive and negative gamma reference voltages V_{GMA1} to V_{GMA10} received from the DC-DC converter 14 and generates positive and negative analog video data voltages to be supplied to the liquid crystal cells Clc. Each source driver IC inverts polarities of the positive and negative analog video data voltages under the control of the timing controller 11 and supplies the inverted data voltages to the data lines D1 to Dm.

The gate driving circuit 13 includes a plurality of gate driver ICs. Each of the gate driver ICs includes a shift register sequentially shifting a gate high voltage V_{GH} and a gate low voltage V_{GL} received from the DC-DC converter 14 in response to the gate control signal GDC to sequentially supply a scan pulse to the gate lines G1 to Gn. The scan pulse is swung between the gate high voltage V_{GH} and the gate low voltage V_{GL}.

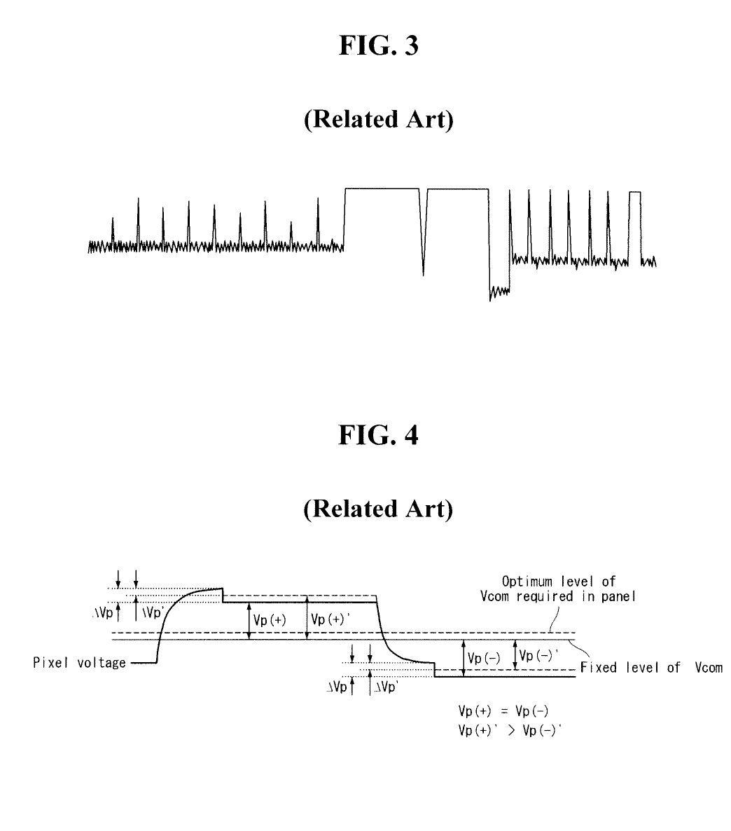

As shown in FIG. 2, the DC-DC converter 14 adjusts the input voltage Vin inside the charge pumping unit 2 in response to a switch control signal input through the boosting switch to generate voltages required to drive the liquid crystal display panel 10. The driving voltages of the liquid crystal display panel 10 includes a high potential power voltage Vdd equal to or less than about 8V, a logic power voltage Vcc of about 3.3V, the gate high voltage V_{GH} equal to or greater than about 15V, the gate low voltage V_{GL} equal to or less than about −3V, the positive and negative gamma reference voltages V_{GMA1} to V_{GMA10}, and the like. The charge pumping unit 2 includes a plurality of diodes and a plurality of capacitors. In the DC-DC converter 14, the pumping capacitor unit 1 including the plurality of pumping capacitors FC1 to FC4 is connected between the boosting switch and the charge pumping unit 2. A level of the output voltage of the DC-DC converter 14 is determined by capacitances of the pumping capacitors FC1 to FC4. The capacitances of the pumping capacitors FC1 to FC4 are generally very less than capacitances of the capacitors inside the charge pumping unit 2. As shown in FIG. 3, when a panel load changes because of changes of a data pattern or changes of a driving frequency, the level of the output voltage of the DC-DC converter 14, for example, a level of the gate high voltage V_{GH} or a level of the gate low voltage V_{GL} changes because of the low capacitances of the pumping capacitors FC1 to FC4.

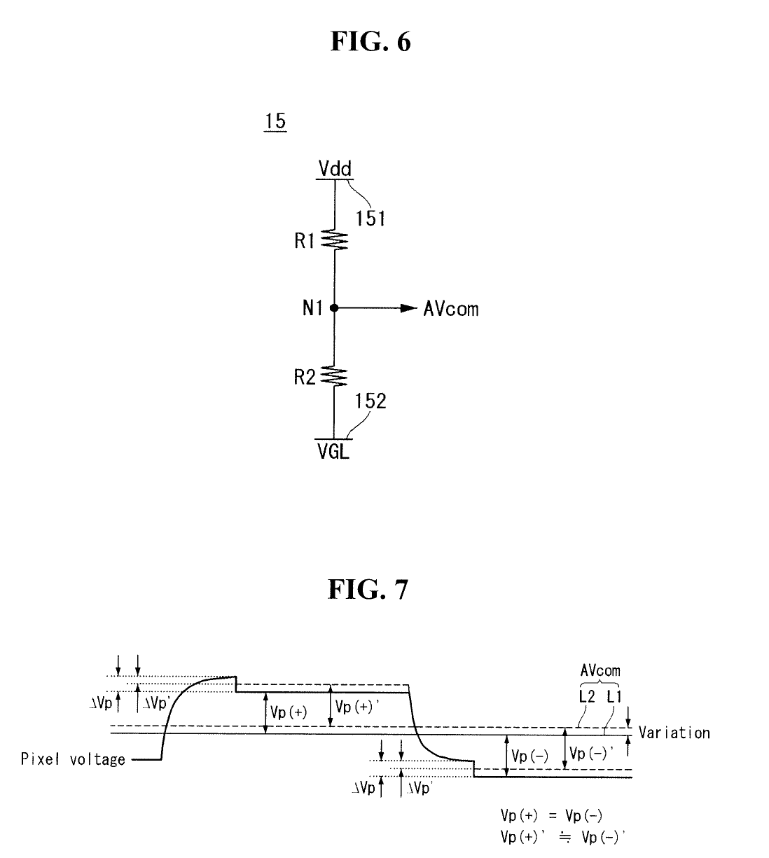

The common voltage generating circuit 15 divides the high potential power voltage Vdd and the gate low voltage V_{GL} generated by the DC-DC converter 14 to generate the common voltage AVcom to be supplied to the common electrode 2 of the liquid crystal display panel 10. The common voltage AVcom is not fixed to an initial setting value unlike a related art, and a level of the common voltage AVcom varies as the panel load changes. The common voltage generating circuit 15 is described in detail below with reference to FIGS. 6 to 9.

The liquid crystal display panel 10 applicable to the embodiment of the invention may be implemented in any liquid crystal mode as well as the TN, VA, IPS, and FFS modes. The liquid crystal display according to the embodiment of the invention may be implemented as any type liquid crystal display including a backlit liquid crystal display, a transflective liquid crystal display, and a reflective liquid crystal display. The backlight unit 16 providing light to the liquid crystal display panel 10 is necessary in the backlit liquid crystal display and the transflective liquid crystal display. The backlight unit 16 may be implemented as a direct type backlight unit or an edge type backlight unit.

FIGS. 6 to 9 illustrate various examples of the common voltage generating circuit 15 according to the embodiment of the invention.

As shown in FIG. 6, the common voltage generating circuit 15 includes a first input terminal 151 to which the high potential power voltage Vdd is input, a second input terminal 152 to which the gate low voltage V_{GL} is input, first and second resistors R1 and R2 that are connected in series to each other between the first and second input terminals 151 and 152 and divide a voltage between the first and second input terminals 151 and 152, and an output node N1 outputting a voltage divided by the first and second resistors R1 and R2 as the common voltage AVcom.

In the related art, a ground level voltage GND whose a level is uniformly fixed irrespective of changes of the panel load is applied to a second input terminal. However, in the embodiment of the invention, the gate low voltage V_{GL} whose a level varies depending on changes of the panel load is applied to the second input terminal 152. When the gate low voltage V_{GL} is applied to the second input terminal 152 and the data pattern or the driving frequency changes, the level of the common voltage AVcom varies and reaches around an optimum common voltage level required in the liquid crystal display panel 10 based on changes in the level of the gate high voltage V_{GH} and changes in the level of the gate low voltage V_{GL}. For example, as shown in FIG. 7, when a driving frequency of the liquid crystal display panel 10 rises in a state where a feed-through voltage is ΔVp and the common voltage AVcom is kept at a first level L1, the level of the gate high voltage V_{GH} rises and the level of the gate low voltage V_{GL} falls. As a result, the feed-through voltage decreases from ΔVp to ΔVp′. When the feed-through voltage decreases, the optimum common voltage level required in the panel 10 has to rise around a second level L2 because the optimum common voltage level of the panel 10 has to be set so that a positive pixel voltage Vp(+) and a negative pixel voltage Vp(−) are symmetric to each other with the common voltage AVcom interposed therebetween. However, because the common voltage AVcom according to the embodiment of the invention is produced by dividing the gate low voltage V_{GL}, a change amount of the gate low voltage V_{GL} is sufficiently reflected in the common voltage AVcom. Therefore, the level of the common voltage AVcom automatically rises around the second level L2. As a result, even if the panel load changes in the embodiment of the invention, the level of the common voltage AVcom may be shifted around the optimum common voltage level required in the panel 10 based on changes of the panel load. Further, before and after the panel load changes, the symmetric structure between the positive pixel voltage Vp(+) and the negative pixel voltage Vp(−) is maintained (i.e., Vp(+)=Vp(−) and Vp(+)′≈Vp(−)′).

The following Table 1 indicates an experimental result of changes in the level of the common voltage when a driving frequency in a 19-inch monitor rises from 60 Hz to 75 Hz.

TABLE 1

| | Driving | Driving |
|---|---|---|
| | frequency | frequency of |
| | of 60 Hz | 75 Hz |
| Optimum common voltage level | 4.72 V | 4.80 V |
| required in panel | | |
| Fixed output of common voltage | 4.72 V | 4.72 V |
| Vcom in related art | | (difference of 0.8 V) |
| Variable output of common voltage | 4.72 V | 4.82 V |
| AVcom in embodiment of invention | | (difference of 0.2 V) |

When the driving frequency rises from 60 Hz to 75 Hz, the level of the gate high voltage V_{GH} falls from about 27.59V to about 26.31V and the level of the gate low voltage V_{GL} rises from about −5.12V to about −4.83V because an insufficient supply current of the pumping capacitors constituting the DC-DC converter 14. The feed-through voltage decreases because of the changes of the levels of the gate voltages V_{GH} and V_{GL}, and as a result the optimum common voltage level of the panel rises from 4.72V to 4.80V. In the related art, when the panel load changes, there is a great difference of 0.8V between the optimum common voltage level (i.e., 4.80V) required in the panel and the output level (i.e., 4.72V) of the related art common voltage Vcom because the output level of the common voltage Vcom is fixed to an initial setting value of 4.72V. On the other hand, in the embodiment of the invention, when the panel load changes, the common voltage AVcom varies and reaches around the optimum common voltage level (i.e., 4.80V) required in the panel based on the changes of the panel load. Hence, there is a small difference of 0.2V between the optimum common voltage level (i.e., 4.80V) and the output level (i.e., 4.82V) of the common voltage AVcom according to the embodiment of the invention.

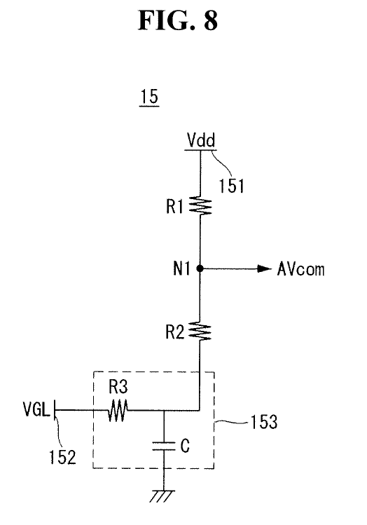

As shown in FIG. 8, the common voltage generating circuit 15 includes a first input terminal 151 to which the high potential power voltage Vdd is input, a second input terminal 152 to which the gate low voltage V_{GL}, is input, first and second resistors R1 and R2 that are connected in series to each other between the first and second input terminals 151 and 152 and divide a voltage between the first and second input terminals 151 and 152, an output node N1 outputting a voltage divided by the first and second resistors R1 and R2 as the common voltage AVcom, and a filter unit 153 for removing a harmonic component from the gate low voltage V_{GL} applied through the second input terminal 152.

The filter unit 153 may be implemented by a RC filter including a third resistor R3 and a capacitor C. The RC filter removes an AC component mixed in the gate low voltage V_{GL} received from the DC-DC converter 14.

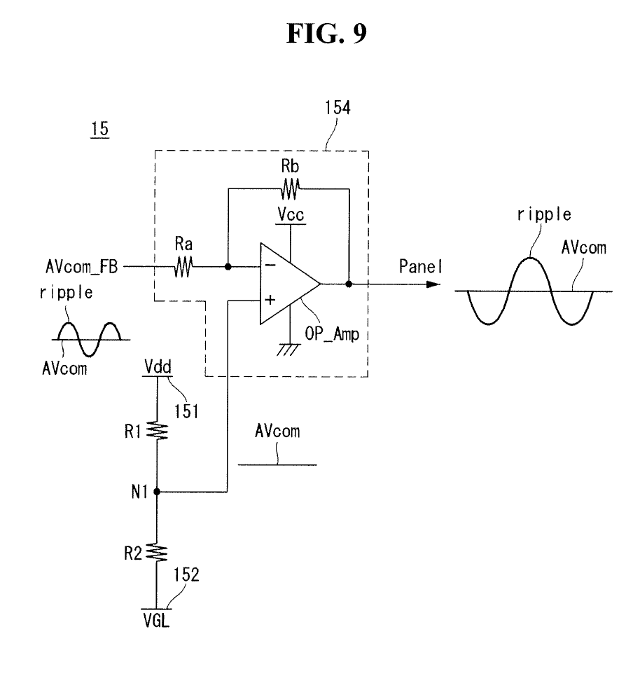

As shown in FIG. 9, the common voltage generating circuit 15 includes a first input terminal 151 to which the high potential power voltage Vdd is input, a second input terminal 152 to which the gate low voltage V_{GL} is input, first and second resistors R1 and R2 that are connected in series to each other between the first and second input terminals 151 and 152 and divide a voltage between the first and second input terminals 151 and 152, an output node N1 outputting a voltage divided by the first and second resistors R1 and R2 as the common voltage AVcom, and a common voltage compensation unit 154 connected to the output node N1.

The common voltage AVcom output through the output node N1 includes only a DC component. However, when the common voltage AVcom is practically applied to the common electrode of the liquid crystal display panel, the common voltage AVcom includes a ripple component because of an influence such as a line resistance and the data voltage. The ripple component of the common voltage AVcom has to be removed so as to achieve the good image quality. The common voltage compensation unit 154 inverts and amplifies the feedback common voltage from the liquid crystal display panel based on the common voltage AVcom input through the output node N1, and then again supplies the amplified common voltage to the liquid crystal display panel. Hence, the common voltage compensation unit 154 removes the ripple component of the feedback common voltage.

The common voltage compensation unit 154 may be implemented by an inverting amplifier including an operational amplifier (op-amp). The op-amp has a non-inverting terminal (+), that is connected to the output node N1 and receives the common voltage AVcom, and an inverting terminal (−) receiving a feedback common voltage AVcom_FB from the liquid crystal display panel. An amplification rate of the op-amp is determined by a ratio −Rb/Ra of resistors Ra and Rb connected to the inverting terminal (−).

As described above, in the liquid crystal display according to the exemplary embodiment of the invention, the common voltage is produced by dividing the high potential power voltage based on the gate low voltage whose a level varies depending on the changes of the panel load. Therefore, when the panel load changes, the level of the common voltage can vary and reach around the optimum common voltage level required in the panel. Accordingly, the liquid crystal display according to the exemplary embodiment of the invention can greatly reduce a side effect such as crosstalk, smear, flicker, and image sticking even if the panel load changes, thereby greatly improving the image quality.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display comprising;
a liquid crystal display panel on which a plurality of data lines and a plurality of gate lines cross each other and a plurality of liquid crystal cells are formed at crossings of the data lines and the gate lines;
a DC-DC converter that produces a high potential power voltage required to drive the liquid crystal display panel and a gate low voltage required to generate a scan pulse for driving the gate lines; and
a common voltage generating circuit that divides the high potential power voltage based on the gate low voltage to generate a common voltage to be applied to a common electrode of the liquid crystal cells.

2. The liquid crystal display of claim 1, wherein the common voltage generating circuit includes:
a first input terminal to which the high potential power voltage is input;
a second input terminal to which the gate low voltage is input;
a plurality of resistors that are positioned between the first and second input terminals and divide the high potential power voltage based on the gate low voltage; and
an output node that outputs a voltage divided by the resistors as the common voltage.

3. The liquid crystal display of claim 2, wherein the common voltage generating circuit further includes a filter unit for removing a harmonic component from the gate low voltage applied through the second input terminal.

4. The liquid crystal display of claim 3, wherein the filter unit is implemented by a RC filter.

5. The liquid crystal display of claim 2, wherein the common voltage generating circuit further includes a common voltage compensation unit connected to the output node.

6. The liquid crystal display of claim 5, wherein the common voltage compensation unit is implemented by an inverting amplifier including an operational amplifier (op-amp).

7. The liquid crystal display of claim 6, wherein the op-amp has a non-inverting terminal, that is connected to the output node and receives the common voltage, and an inverting terminal receiving a feedback common voltage from the liquid crystal display panel,
wherein the common voltage compensation unit inverts and amplifies the feedback common voltage from the liquid crystal display panel based on the common voltage input through the output node, and then again supplies the amplified common voltage to the liquid crystal display panel, thereby removing a ripple component of the feedback common voltage.
